(19) United States
(12) Patent Application Publication
(10) Pub. No.: US 2007/0284242 A1
(43) Pub. Date: Dec. 13, 2007

(54) Method For Treating Gases By High Frequency Discharges

(76) Inventors: Michel Moisan, Outremont, Que (CA); Jean-Christophe Rostaing, Versailles (FR); Martine Carre, Chesnay (FR)

Correspondence Address: AIR LIQUIDE;Intellectual Property, 2700 POST OAK BOULEVARD, SUITE 1800, HOUSTON, TX, 77056, US

(21) Appl. No.: 10/585,170

(22) PCT Filed: Dec. 23, 2004
(86) PCT No.: PCT/FR04/50751

§ 371 Date: Apr. 10, 2007

(30) Foreign Application Priority Data
Jan. 6, 2004 (FR) 0450016

(51) Int. Cl. B01D 53/32; B01D 53/70; B01J 19/12; C25D 17/00

(52) U.S. Cl. 204/165; 204/194

(57) ABSTRACT

The invention relates to a method for the treatment of gases comprising impurities, in which the gas, which is essentially at atmospheric pressure, is subjected to a radio-frequency inductive plasma (RF-ICP) discharge.

### TECHNICAL FIELD AND PRIOR ART

The invention relates to the field of gas treatment, particularly at atmospheric pressure by plasma techniques.

High density electrical discharges are very advantageous for carrying out industrial gas purification and pollution control treatments.

The principle consists in causing physicochemical conversions of impurities and/or pollutants present in a carrier gas, in the discharge, to obtain new compounds which can then be removed from the gas stream, for example by conventional post-treatment, such as reactive adsorption.

The field of use of these discharges corresponds to higher typical concentrations (from a few thousand parts per million by volume (ppmv)) and lower throughputs than those used for corona discharges and dielectric barrier discharges (DBD), which are more often mentioned for gas pollution control applications.

The applicant has developed such methods, particularly by microwave discharges at atmospheric pressure, which are maintained by surface waves. These methods are used to lower the residual CF₄ and CH₄ concentration in the krypton and xenon extracted from the air by cryogenic concentration, to below 1 ppmv. Another application relates to the removal of perfluorinated gases (PFC) or hydrofluorocarbon compounds (HFC), which are greenhouse gases (CF₄, C₂F₆, SF₆, c-C₄F₈, C₃F₈, NF₃, CHF₃, etc.), effluents released by semiconductor manufacturing equipment. These effluents result particularly from plasma cleaning operations on thin layer deposition reactors and plasma etching operations on the same thin layers.

The very high electron density of these microwave discharges (10¹²-10¹⁵ cm⁻³) is particularly suitable for the concentration (a few thousand ppmv) and dilution nitrogen throughput (a few tens of standard liters per minute (slm)) conditions prevailing at the exhaust of the primary vacuum pumps of semiconductor thin layer deposition and etching equipment.

In the case of PFC, the high energy electrons available serve to cause frequent inelastic collisions of electrons on the PFC molecules and thereby largely dissociate them.

At the same time, these collisions prevent the reformation of the PFC before their fragments have reacted with oxidizing species to yield stable final products, particularly corrosive fluorine compounds (COF₂, SO₂F₂, F₂, HF, etc.) which can be removed easily from the gas stream by conventional post-treatment such as, for example, reactive adsorption or neutralization on an alkaline solution.

Microwave atmospheric plasmas are not generally in local thermodynamic equilibrium (LTE), but they are not very far removed from this condition. The electron energy distribution is centered on relatively low values (2 to 3 eV) giving rise to a large number of elastic collisions on the heavy particles, which has the effect of effectively heating the gas. Thus, the temperature of the heavy species of the medium, neutrals and ions, is not lower than about 1/10 of the electron temperature, or still several thousand K on average. Since it is desirable to maintain the gas close to the tube wall at a temperature compatible with the physical integrity of the wall, a fairly high radial temperature gradient exists. This is in turn reflected by an increase in the gas density from the axis toward the periphery. As the density rises, it is known that the ionization yield decreases and the recombination of the charged particles is promoted, causing a drop in electron density from the axis toward the tube wall.

This mechanism is even fairly pronounced because, for relatively low tube diameters (a few mm) the plasma no longer fills the entire tube cross section in certain cases.

The discharge is said to be contracted, and the process can evolve toward the formation of several plasma filaments (filamentation mechanism) in random movement in the tube cross section.

Thus, a zone always exists at the tube periphery where the gas is much colder and the electron density lower, hence where the dissociation of the PFC molecules is less probable and their reformation promoted.

This radial contraction is accentuated with the increase in molecular weight of the gas, its speed of passage, the excitation frequency, and the tube inside diameter.

Furthermore, while a surface wave plasma column lengthens when the microwave power supplied to the applicator is increased, on the other hand, this increase in power has practically no effect on the shape of the radial plasma density distribution. Thus increasing the power cannot ensure that the plasma will fill the tube cross section more completely.

As a result, the useful diameter of the discharge tube is in any case limited and it is illusory to hope thereby to increase the treatment capacity.

Multitube surface wave plasma sources have been developed to overcome this intrinsic limitation. Yet the scaling-up possibilities are again limited by the microwave power that can be caused to circulate in a single waveguide.

Furthermore, the radial electron density gradient limits the conversion rate if the throughput is high and the plasma column is short. This is the case in particular of the destruction of PFC in nitrogen, with columns not longer than about 150 mm.

On the contrary, in Kr/Xe purification, the plasma column measures over 500 mm on average and a conversion yield above 99.9% can be reached for CF₄, although the plasma is highly contracted and filamentary. This is due to the fact that the PFC molecules, along their path, then have more time to migrate from the cold zones toward the hot zones, where they have been entrained by diffusion, convection or turbulence. This is also due to the fact that unlike discharges in nitrogen or another molecular gas, “quenching” or extinction reactions are very limited.

A system with one or two tubes can deal with gaseous effluents from one or two multichamber platforms, and offer major technical and economic advantages in this configuration over more conventional solutions such as burners.

However, operating situations also exist in which much higher capacity is necessary.

This is the case, for example, of the treatment of gaseous effluents from the fabrication of liquid crystal display screens (TFT-LCD).

These also make use of methods for depositing and etching thin layers based on silicon. However, due to the unit size of the substrates (up to 1.00 m sides, compared with the 300 mm maximum diameter of a slice of monocrystalline silicon) the volumes of gaseous effluents released by a chamber of the method are many times higher than those conventionally treated in microelectronics, particularly for the manufacture of CMOS or dipole components on monocrystalline silicon.

Because of the limited scaling-up due to radial contraction, atmospheric microwave plasma cannot provide an appropriate solution for these applications.

This raises the problem of finding a novel method and a gaseous effluent treatment device compatible with the high throughputs of these effluents.

Another problem is to find a novel method and a novel gaseous effluent treatment device, at substantially atmospheric pressure, complementary to known treatments, particularly microwave plasma treatments maintained by surface waves.

According to another aspect, a further problem is to find a method and a device not subject, or less subject than known methods, to the limitations imposed by radial plasma contraction.

### SUMMARY OF THE INVENTION

The invention uses a high density electron plasma maintained by a radiofrequency electromagnetic field at least partially or mainly in inductive coupling mode, widely called “Inductively Coupled Plasma” or abbreviated to ICP.

A primary object of the invention is a method for treating gases, comprising impurities, in which the gas at substantially atmospheric pressure is subjected to a radiofrequency inductively coupled plasma (RF-ICP) discharge.

The invention also relates to a system for treating gases by plasma, comprising means for producing a gas to be treated at a pressure substantially equal to atmospheric pressure and means for producing a radiofrequency inductively coupled plasma.

An RF-ICP plasma serves to reach a high electron density, particularly in comparison with, for example, corona or dielectric barrier discharges, or with mainly capacitive coupling radiofrequency plasmas.

Furthermore, the electron density in RF-ICP plasmas is generally higher than that which can be obtained in an atmospheric microwave plasma, particularly excited by a surface wave.

The behavior of an RF inductively coupled plasma is further substantially different from that of atmospheric microwave discharges with surface waves. This behavior makes it an alternative or complementary medium to atmospheric microwave plasma for treating gases, particularly for their purification and pollution control by plasma, and particularly at atmospheric pressure.

Among other factors, RF-ICP plasmas are not restricted to the same scaling-up limitations.

Radiofrequency inductively coupled discharges, close to local thermodynamic equilibrium (LTE), effectively serve to obtain different and complementary physicochemical conversions to those that can be accomplished by other techniques, and particularly by microwave discharges which, even at atmospheric pressure, are relatively outside LTE.

The invention serves in particular to maintain RF-ICP discharges, in inductive mode with a transverse electric or TE or type H field structure, or in mixed modes coupled with the transverse magnetic or TM or type E field mode, which both fill a large part of the tube cross section. The diameter of such torches may be between 8 and 160 mm at atmospheric pressure, and may even be higher at reduced pressure. The frequencies vary according to the size of the torch and the power, from 200 MHz at low power, up to 100 kHz, or even 50 kHz according to the generator technology.

This serves to treat higher throughput ranges complementary to those treated by microwave technology.

According to one embodiment, the discharge uses a silica glass torch, for example, with a double wall for circulation of a cooling liquid between the two walls.

It may also use a refractory torch, for example a ceramic torch and more particularly a standard grade alumina torch.

According to a further variant, the discharge uses a metal torch according to the cold cage segmentation technique.

According to another variant, the discharge comprises at least one temperature zone above 5000 K.

An additional treatment, for example, using a reactive element, can be provided, in order to cause the compounds resulting from the plasma treatment to react and thereby destroy them.

According to one variant, the treated gas throughput is between 0.2 and 25 m³/h.

The treated gas contains a perfluorinated (PFC) or hydrocarbon or hydrofluorocarbon (HFC) gas as species to be treated by plasma. This gas is, for example, a rare gas or a gas issuing from a reaction chamber, particularly in the field of semiconductor production.

The method and the device according to the invention are moreover particularly suitable for treating gases comprising gaseous effluents issuing from a display screen manufacturing process, in which the effluent throughputs may be as high as several liters per minute (slm) (under standard temperature and pressure conditions), for example between 1 slm and 20 slm, or a total of 100 to 2000 slm not counting the addition of dilution nitrogen at the exhaust of the primary pumps.

The gas to be treated may also be a gas comprising gaseous effluents issuing from a method for producing or growing materials or for etching or cleaning or treating flat screens or semiconductors or semiconducting or conducting or dielectric thin layers or substrates, for example comprising gaseous effluents issuing from a method for producing or growing materials or for etching or cleaning or treating silicon thin layers.

The reactor may also be a reactor for shrinking photosensitive resins used for microcircuit lithography, or a reactor for depositing thin layers during plasma cleaning.

### BRIEF DESCRIPTION OF THE FIGURES

FIGS. 1, 2, and 4 show torches which can be used in the context of the present invention.

FIG. 3 shows a system for analyzing gases after plasma treatment.

FIG. 5 shows a diagram of a unit for producing semiconductors and treatment means according to the invention.

### DESCRIPTION OF EMBODIMENTS OF THE INVENTION

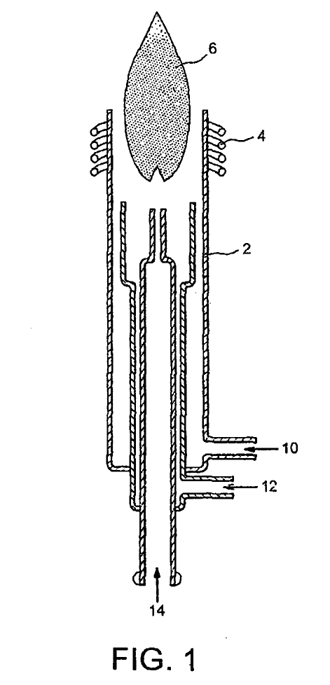

As shown in FIG. 1, a radiofrequency inductively coupled plasma (RF-ICP) is obtained in a gas confined in a tube 2.

The excitation means comprise an inductor 4, surrounding the tube 2, and which is traversed by a radiofrequency (RF) current. This inductor is connected to radiofrequency power generating means, not shown in the figure.

It is thereby possible to maintain an RF discharge, particularly by inductive coupling, between the inductor 4, which constitutes the primary of a transformer, and the plasma 6 which constitutes a single turn secondary.

The tube 2 serves to confine the plasma and to prevent direct contact between the two conductors, which are the inductor 4 and the plasma 6. This tube may further be equipped with cooling means, not shown in FIG. 1.

In this FIG. 1, the numeral 10 denotes a plasma generating gas, for example nitrogen, the gas to be converted by plasma being the gas 14. An auxiliary gas 12 can be introduced to adjust the properties of the plasma or to carry out particular chemical reactions (for example, an oxidizing gas such as oxygen, steam, etc.).

It is also possible to introduce a plasma generating gas 10 already mixed with a gas to be treated.

According to another variant, and for reasons of discharge stability and for greater operating flexibility, use can be made of assemblies of several concentric tubes for introducing various gas streams into the inductor zone. This assembly of tubes is generally called a torch or applicator.

The frequencies used for the RF excitation field range from 50 kHz, or 100 kHz or 200 kHz to 100 MHz or more, for example to 200 MHz. The power supplied may, for example, vary from 100 or a few hundred watts to a few megawatts, for example from 100 w or 300 w to 1 MW or 5 MW. The current generating means are selected accordingly.

According to the invention, an RF-ICP discharge is generated at pressures, substantially atmospheric, ranging between a few pascals and several bar, for example between 0.05 bar or 0.1 bar or 0.5 bar and 1.2 bar or 1.5 bar or 2 bar or 5 bar. If the pressure at the outlet of a process is insufficient or lower, for example, than 0.1 bar, pumping means can be used to reach the desired pressure at the plasma inlet.

Close to atmospheric pressure, or in the pressure ranges indicated above, and if the frequency does not exceed around 10 megahertz (and is therefore lower than 10 MHz or 20 MHz), such a plasma discharge, contrary to atmospheric microwave discharges, is considered as being in local thermodynamic equilibrium (LTE). As the frequency rises or the pressure decreases, it deviates progressively from LTE.

The gas treatment methods developed using such discharges are therefore different from those used with plasmas which are more or less outside equilibrium, such as surface wave microwave discharges.

Thus novel possibilities are available for developing gaseous effluent treatments in a large number of practical industrial cases.

This type of plasma, without electrodes, further constitutes a high purity medium and can advantageously be applied to methods for industrial gas pollution control and purification treatment.

It is the thermal effect of the plasma used that dissociates the pollutant molecules.

During the cooling of the gases after passage through the plasma, this dissociation serves to reform different chemical combinations, having physicochemical properties distinct from those of the initial molecules.

Thus, either these species remain without any disadvantage and definitively as such in the gas stream, or they are removed therefrom by complementary treatment means.

The outlet of the plasma reactor can be connected to means or an extraction system for collecting the gas stream in a sealed manner to convey it to such complementary treatment means.

These treatment means may be particularly of the type based on an irreversible reaction with an appropriate solid or liquid medium. Thermal or thermocatalytic treatment means, or adsorption or cryogenic means, may also be used. One example is a reactive alkaline adsorbent used to remove the corrosive fluorinated gases resulting from the conversion of the PFC.

Various types of torch can be used, the choice thereof depending on the planned application and the power employed.

A first possible type of torch is a silica glass torch. This material is used for its thermomechanical strength properties. This type of torch is intended for low power applications, for example from 1 to 5 kW, according to size and throughput.

As the power increases, torches having a double wall structure can be used, defining an interstitial space for circulating a cooling fluid which may be water.

In fact, contrary to what occurs in the hyperfrequency range, water does not substantially absorb the electromagnetic power in the radiofrequency domain and hence there is no need to resort to a dielectric heat transfer liquid, of which the choice is not always an easy matter.

With such cooling, power levels of about 50 to 80 kW can be reached.

Another type of possible torch is the refractory torch, for example a ceramic torch.

One drawback of cooled silica torches is their brittleness, and their short service life in the case of a corrosive fluorinated environment. On the contrary, ceramic torches permit operation without a cooling liquid, up to power levels of about 50 to 100 kW. They are much less delicate than glass torches, both from the thermal and mechanical standpoint.

Contrary to microwave discharges, relatively common ceramics can be used in standard purity grades, such as commercial alumina. For example, a 98% pure alumina, conventionally available in tubes of various sizes in catalogues of technical material suppliers, is suitable. In fact, there are no problems of dielectric losses increasing with temperature, due to the impurities (residues of sintering binders) which, outside the radiofrequency domain, above 433 MHz and particularly at 2.45 GHz, can cause failures by thermal runaway mechanisms, leading to the choice, for microwave atmospheric discharge tubes, of a specific and costly material such as aluminum nitride with very high purity specifications.

In general, the torch wall temperature can be increased by using a refractory that does not require cooling. The cold peripheral layer is thereby reduced.

A third type of possible torch is the metal torch, consisting of a set of metal segments (or “fingers”) cooled by water circulation. The currents induced by the inductor are closed at the surface of each finger.

A current accordingly flows on the inside of each finger, the image of the current flowing in the inductor, and causing the appearance of an induced current in the plasma.

Everything proceeds as if the metal wall, due to its segmentation, had become transparent to the electromagnetic field.

This type of torch can withstand power levels of about one megawatt, and can be used from 5 kW. Its drawback is the direct losses in the segments themselves by the Joule effect. These losses are about 10%, and depend on the frequency and power.

These metal torches are suitable for the pollution control treatment of very high gas throughputs, particularly between 20 and 400 l/min.

Such a metal torch, cooled by water and operating at high power, can be used to increase the diameter of the plasma and force it to approach the wall. The cold peripheral zone is thereby reduced.

Several types of discharge can be obtained, each having specific characteristics.

The “H” or TE type discharge is the specifically inductive discharge.

In this type of discharge, the induced current lines close and form the secondary of a transformer. The discharge then assumes the shape of a highly luminous oblong candle flame.

When, at constant pressure, the power applied increases, for example from 5 to 60 kW in a 35 to 50 mm diameter torch, the volume of the discharge increases in diameter and length and progressively fills the entire tube cross section.

In consequence, even for high tube inside diameters (for example several cm, for example at least 2 cm and up to 10 cm or 15 cm), it is possible, by applying a sufficient power, to maintain RF inductively coupled plasmas having a significant action on all the gas molecules passing through the tube section.

This is a major advantage for certain applications compared with surface wave microwave discharges which are affected by the radial contraction and filamentation.

This property serves to treat much higher throughputs, up to 400 l/min, without increasing the number of plasma modules.

When the discharge approaches the tube walls, the heating of the tube increases. Cooling means then make it possible to operate reliably at the highest power levels.

The “E” or TM type discharge is in the form of single or multiple filaments, longitudinal, or in the form of a luminous needle along the tube axis.

This type of discharge is often surrounded, particularly in large diameter tubes, by a less luminous diffuse zone. In this case, the current lines are not closed, and the discharge results from the capacitive effect existing between the turns of an inductor. Since the currents are not closed, they are much lower than in the case of the H discharge, and the power is lower. This type of discharge is hence not truly of the inductive type, but rather of the capacitive type.

An E type discharge is often observed fleetingly upon ignition, just before the switch to inductive mode.

As to the mixed discharge, it occurs when, in a long tube, from 20 cm to more than 1 m after the inductor, the power applied to an H type discharge is progressively increased, for example above 2 to 5 kW in a 30 mm tube. Prolongation of the discharge is then observed outside the applicator zone, in the form of a needle terminating in a very elongated cone shape along the tube axis.

In voltage controlled generators, this transition corresponds to a rapid increase in current, and hence in power.

In these mixed conditions, increasing the power has the effect of increasing the length of the slender downstream part of the discharge.

If the throughputs are not too high, for example 20 l/min in a 30 mm tube, the mixed conditions serve to develop compromise solutions also taking advantage of an increase in residence time to reinforce the conversion efficiency, without the need to favor the radial expansion of the discharge, and thereby maintain the thermal loads on the wall at a reasonable level.

For a given geometry, and particularly in H type or mixed discharges, an increase in electric power results in an increase in plasma size, particularly its diameter, and hence a reduction of the cold boundary layer.

E type discharges mainly react to a power increase by an increase in length.

An E type discharge, like the slender downstream part of mixed discharges, has the following advantage: by increasing the residence time of the species, they experience a higher probability, during their travel in the discharge, of moving from the cold peripheral zone to the hot central zone, under the effect of diffusion, convection or turbulence of the flow close to the wall.

When the pressure drops, particularly to pressures close to 100 pascals, all the types of discharge tend to increase in volume and progressively fill the entire confinement tube. At low pressure, all the discharges obtained in a chamber surrounded by an inductor are mainly coupled capacitively: since the carrier density is low, the current density remains low and the axial electric field between the turns leads mainly to E type discharges.

As the pressure increases, and under coupling and power conditions leading at atmospheric pressure to an H type discharge, the transition is observed to inductive mode, at a pressure of about 50 to 300 hPa.

The discharge then rapidly becomes highly luminous. This type of plasma is accordingly at local thermodynamic equilibrium, or very close to LTE.

The reduction of the plasma boundary layer close to the wall of the torch plays an important role from the yield standpoint. In this zone, the plasma is cooled by said wall. The gases passing through this cold zone are hence no longer heated to high temperature, the molecules are not entirely dissociated, their reformation is favored, and conversion is incomplete.

It is not materially possible to have a very high wall temperature without causing the destruction of this wall.

It is therefore impossible to obtain a conversion yield of exactly 100% through this approach, but the reduction of the “cold” zone close to the wall plays an important role for approaching this ideal limit.

This reduction can be obtained in various ways: by the choice of the type of torch (materials, geometry, etc.), by the plasma power, by the choice of the mode for coupling the RF power to the discharge.

One field of application of the invention concerns purification and pollution control.

This may, for example, concern the purification by plasma of krypton/xenon mixtures leaving a recovery unit added to an air gas separation installation, the implementation of which is described in application EP 0 847 794.

It is also possible, at higher concentrations and in various plasma generating carrier gases, to remove gaseous pollutants which are immediately dangerous to life and health, or harmful to the environment in the longer term.

These are particularly hydrocarbon, perfluorinated or hydrofluorocarbon or perchlorinated or hydrochlorocarbon compounds.

Unlike other types of treatment of polluted gases based on plasmas out of equilibrium or at low pressure, the radiofrequency inductively coupled plasma technology uses and favors the chemical reactions indicated by thermodynamics.

The reactor consists of a plasma torch like the one in FIG. 1, in which the gases 14 to be purified are introduced.

The plasma is formed from the majority carrier gas (plasma generating gas 10), for example a krypton/xenon mixture, or argon, or nitrogen or air.

Before this gas is introduced into the torch, or after it has been introduced, a reactive gas 12 can be added to this gas, in an adequate quantity that depends on the concentration of the pollutant to be converted, said reactive gas 12 being, for example, oxygen, which participates in the conversion chemistry.

The invention serves in particular to destroy perfluorinated pollutants (CF₂ and/or CH₄) in a rare gas (argon, krypton or xenon) to be purified.

In order to be removed by post-treatment on an alkaline medium, these gases are converted respectively to HF or H₂F₂, or to CO or CO₂.

Oxygen can be added as a reagent gas 12, to form other byproducts, particularly anhydrous, and/or complete the oxidation of CH₄ or other hydrocarbons to CO₂, preferably to CO and, optionally, introduce water if the quantity of CH₄ naturally present is insufficient to supply all the hydrogen required to convert the fluorine to HF.

Consider, for example, a unit throughput per tube of 17 standard liters per minute (slm), or about 1 m³/h, representative of the orders of magnitude encountered in an industrial unit producing krypton and xenon.

The torch selected is of the dual-flow type with a silica tube 2. The plasma generator is at a frequency of 27 MHz.

The configuration of the system is shown in FIG. 1.

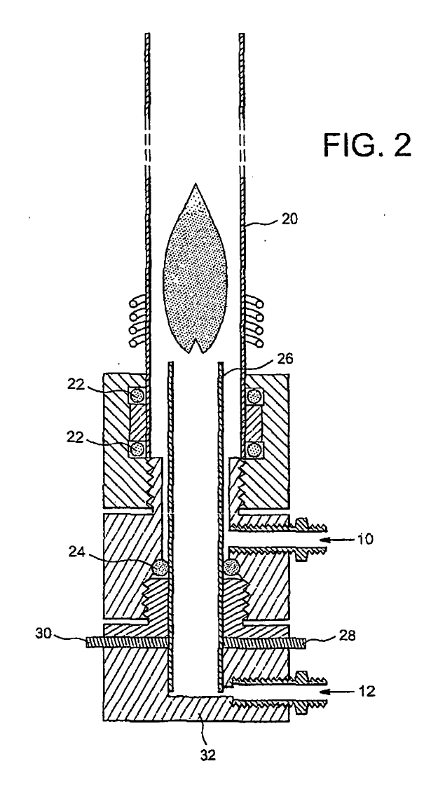

As shown in FIG. 2, another configuration comprises a tube 26 and an additional tube length 20. Appropriate seals 22, 24 are used to close the collection and sampling circuit.

The tube 26, with inside diameter 14 mm and outside diameter 16 mm, terminates about 1 mm below the coil. It is centered in the outer tube 20 (inside/outer diameter 18 mm/20 mm) via screws 28, 30, two of them equipped with springs, arranged around a teflon base 32. The outer tube 20 is, for example, 700 mm long or longer.

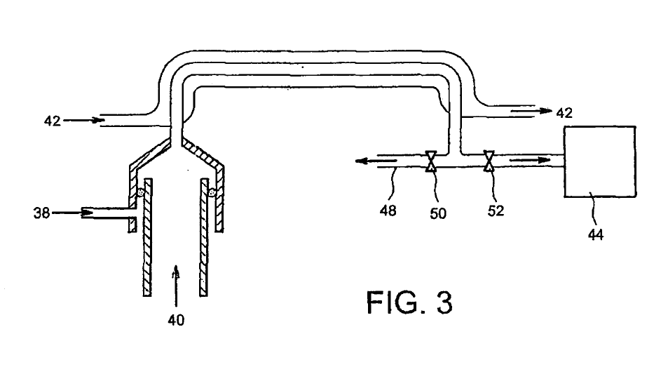

FIG. 3 shows the system conveying the treated gas 40 to an analysis spectrometer 44. The gases 40 issuing from the plasma are cooled by a water flow 42, to remove the enthalpy. The gas impurity conversion products are conventionally analyzed by Fourier transform infrared absorption spectrometry. The numeral 46 denotes a ventilation outlet and the numerals 50, 52 two valves or one 3-way valve for sending, as required, part of the gases to the analytical cell. The numeral 38 denotes a cooling air injection around the outlet of the plasma torch.

The raw rare gas mixture tested contains 127 parts per million by volume (ppmv) of CF₄, a similar CH₄ concentration and traces of SF₆.

A first experiment is performed with a rare gas throughput of 17 standard liters per minute (slm), at an RF power of 900 W.

The 95% CF₄ conversion yield is measured, the CH₄ and SF₆ bands no longer being detectable. An SiF₄ band also appears, reflecting corrosion of the silica tube by the corrosive fluorinated byproducts.

To perform prolonged experiments, the air cooled tube 38, which is strongly heated, is replaced by a water cooled tube.

The inside diameter of the inner tube 26 is then between 10 mm and 12 mm, that of the outer tube 20 between 14 mm and 16 mm, the water passage having a thickness of about 1 mm.

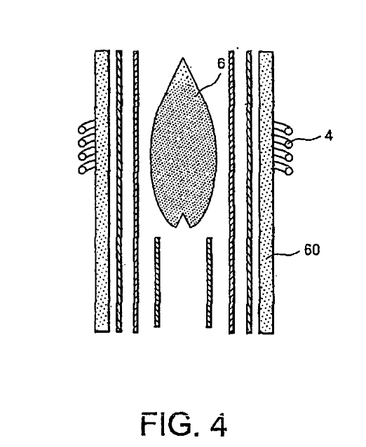

According to one variant, a teflon insulating tube section 60 is arranged surrounding the tube at the turn (FIG. 4). This teflon tube ensures an accurate centering of the tubes and the plasma with respect to the inductor, thereby avoiding even minor variations in the geometry of the system.

In the krypton/xenon mixture, and for a power level between 1.2 kW and 1.5 kW, CF₄ conversion rates of between 95% and nearly 100% were observed (Table 1).

TABLE 1

| | Power | | |
|---|---|---|---|
| | displayed | Throughput | Destruction |
| Test | (kW) | (slm) | rate (%) |
| 1 | 1.2 | 17 | 100 |
| 2 | 1.2 | 17 | 92 |
| 3 | 1.2 | 17 | 90 |
| 4 | 1.2 | 17 | 95 |
| 5 | 1.2 | 17 | 100 |
| 6 | 1.2 | 17 | 90 |

If a major contribution is assigned to E mode, obtained for example in an 8 mm inside diameter tube, the destruction rates are lower than those indicated above (rates of about 60 to 80% were observed), but not negligible. Mixed mode can therefore offer a real advantage, alongside H mode, to develop optimized gas treatment methods. The use of mixed modes offers the advantage of favoring certain elementary chemical processes which require longer residence times.

Another application is the destruction of pollutants in nitrogen or air for typical throughputs of effluents of deposition and etching processes connected with the manufacture of semiconductors or display screens.

In the operating conditions of a microwave atmospheric plasma, the increase in destruction efficiency as a function of power is clearly observed, but in practice, this power is limited, for a tube with an optimized inside diameter of about 8 mm, to about 5 kW, long before the length of the plasma column becomes much higher than about 150 to 200 mm.

Beyond this power value, the long term behavior of the dielectric tube is no longer guaranteed. The degradation mode is initiated by an excessive temperature at the outer wall of the discharge tube in contact with the boundary layer of dielectric cooling fluid. The tube may begin to polymerize into a deposit of carbon residues absorbing microwaves, in their turn locally increasing the surface temperature with a risk of thermal runaway. Under these conditions, frequency of preventive maintenance becomes unacceptable.

Under these conditions, the use, according to the present invention, of a radiofrequency inductively coupled plasma in nitrogen, is perfectly advantageous.

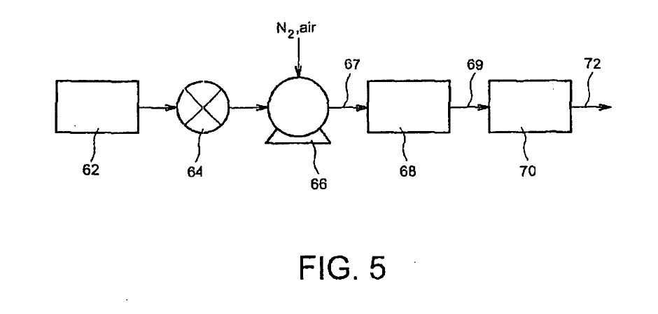

FIG. 5 schematically shows the implementation of the invention in the context of an installation producing semiconductors.

Such an installation, equipped with a treatment system according to the invention, comprises a production reactor, or an etching machine 62, a pumping system comprising a secondary pump 64, such as a turbomolecular pump, and a primary pump 66, means 68 for destroying PFC and/or HFC compounds, of the RF-ICP plasma generator type.

In operation, the pump 64 maintains the necessary vacuum in the process chamber and extracts the discharge gases.

The reactor 62 is supplied with gas for treating semiconductor products, and particularly PFC and/or HFC. Thus gas supply means supply the reactor 62 but are not shown in the figure.

The means 68 for carrying out a treatment (dissociation or irreversible conversion) of these unused PFC and/or HFC compounds, may also similarly produce byproducts, such as F₂ and/or WF₆ and/or COF₂ and/or SOF₂ and/or SO₂F₂ and/or SOF₄ and/or NO₂ and/or NOF and/or SO₂.

These means 68 are means for dissociating the gas molecules entering the means 68, yielding smaller fragments which recombine and/or react together to form reactive compounds, particularly fluorinated compounds.

A reactive element 70 is suitable for reacting the compounds resulting from the treatment by the means 68 with a corresponding reactive element (for example: a solid reactive adsorbent) in order to destroy them.

The gases resulting from the treatment by the means 70 (in fact: the carrier gas laden with compounds of PFC and/or HFC type and/or other impurities like those mentioned above) are then discharged to the surrounding air, but without danger, with proportions of PFC and/or HFC compatible with environmental conservation (typically: less than 1% of the initial concentration) and highly reliable and authorized proportions of dangerous impurities, that is, lower than the legal exposure limits, typically lower than 0.5 ppmv or lower than 1 ppmv according to the type of toxic, corrosive, combustible, pyrophoric or explosive gas concerned.

The gas circuit of the overall system treatment means in FIG. 5 further comprises, starting from the primary pump 66, the line 67 conveying the effluents to the plasma reactive module 68, and the line 69 connecting the plasma to the byproduct post-treatment device 70, and finally the atmospheric discharge line 72 of the detoxified gases which can be released without danger. Added thereto are various fluid management components (bypass valves, purge and insulation utilities for maintenance) and safety sensors (throughput, overpressure fault alarms), not shown in FIG. 5. The circuit components are selected to be compatible with the products in contact with them for reliable operation.

Stoving or trapping systems may also be present.

One advantage of the invention is that the plasma can be maintained in a tube of substantially higher inside diameter, of 10 mm to 15 mm or to 20 mm, than in the case of the surface wave microwave plasma (diameter 4 to 8 mm).

In H or mixed mode, by injecting a sufficient RF power, the plasma tends to substantially fill the entire cross section of the tube so that practically all the pollutant gas molecules passing through said cross section are heated to a high temperature, favoring their dissociation and inhibiting their reformation.

It is possible to add much higher power levels to an inductor, up to 5 MW, than in a waveguide at 2.45 GHz for example, in order to treat total effluent throughputs of 2 to 30 m³/h or more at acceptable cost and size.

The presence of residual impurities in the ceramics used is much less harmful, in the radiofrequency range in terms of absorption of the RF field, than in the case of the surface wave microwave discharge. Simple alumina tubes of routine commercial grade suffice to guarantee a relatively long service life against chemical corrosion by corrosive fluorine compounds. They are not in fact subject to additional loads due to the residual absorption of microwaves by their material.

According to the invention, relatively high pollutant conversion efficiencies can hence be obtained by using a radiofrequency inductively coupled plasma.

1-30. (canceled)

31: A method for treating gases, comprising impurities, in which the gas at substantially atmospheric pressure is subjected to a radiofrequency inductively coupled plasma discharge.

32: The method of claim 31, the coupling to the discharge being of the transverse electric (TE) inductively coupled or H type.

33: The method of claim 31, the coupling to the discharge being of the transverse magnetic or E type.

34: The method of claim 31, the discharge being of the mixed E-H type.

35: The method of claim 31, the discharge being produced at a frequency between about 50 kHz and about 200 MHz.

36: The method of claim 31, the discharge taking place in a tube with an inside diameter of between about 5 mm or about 10 mm and about 50 mm or about 150 mm.

37: The method of claim 31, the discharge using a silica glass torch.

38: The method of claim 37, the torch having a double wall with circulation of a cooling liquid between the two walls.

39: The method of claim 37, the power of the torch being between about 1 and about 1000 kW.

40: The method of claim 31, the discharge using a refractory torch.

41: The method of claim 40, the torch being a ceramic or alumina torch.

42: The method of claim 31, the discharge using a metal torch.

43: The method of claim 31, the treated gas being a rare gas containing a perfluorinated (PFC) or hydrocarbon or hydrofluorocarbon (HFC) gas.

44: The method of claim 43, the discharge comprising at least one temperature zone above about 5000 K.

45: The method of claim 43, in which oxygen and/or water is also added.

46: The method of claim 31, the throughput of treated gas being between about 0.2 and about 25 m³/h.

47: The method of claim 31, the treated gas comprising gaseous effluents issuing from a method for producing or growing or etching or cleaning or treating semiconductors or semiconducting or conducting or dielectric thin layers or substrates.

48: The method of claim 31, the treated gas comprising gaseous effluents issuing from a method for producing or growing or etching or cleaning or treating silicon thin layers.

49: The method of claim 31, the treated gas comprising gaseous effluents issuing from a method for producing display screens.

50: A system for treating gases by plasma, comprising means for producing a gas to be treated at a pressure substantially equal to atmospheric pressure and means for producing a radiofrequency plasma.

51: The system of claim 50, the means for producing a radiofrequency plasma comprising a tube with an inside diameter of between about 5 mm or about 10 mm and about 50 mm or about 150 mm.

52: The system of claim 51, the means for producing a radiofrequency plasma comprising a silica or refractory torch or a metal torch.

53: The system of claim 50, further comprising means for cooling the means for producing a radiofrequency plasma.

54: The system of claim 50, the means for producing a radiofrequency plasma comprising means for generating a current at a frequency of between about 50 kHz and about 200 MHz.

55: The system of claim 50, the means for producing a gas to be treated at a pressure substantially equal to atmospheric pressure comprising pumping means of which the outlet is at a pressure substantially equal to atmospheric pressure.

56: The system of claim 50, comprising a reactive element (70) for reacting the compounds resulting from the plasma treatment (68) for their destruction.

57: A reactor device comprising a reaction chamber (62), producing at least one perfluorinated (PFC) or hydrofluorocarbon (HFC) gas, and further comprising a system for treating perfluorinated (PFC) gas or hydrofluorocarbon (HFC) gas of claim 50.

58: The device of claim 57, the reaction chamber (62) forming part of a unit for producing or growing or etching or cleaning or treating flat screens or semiconducting devices or thin layers or semiconducting or conducting or dielectric thin layers or substrates, or being a reactor for shrinking photosensitive resins used for microcircuit lithography, or a reactor for depositing thin layers during plasma cleaning.

59: A unit for producing or growing or etching or cleaning or treating flat screens or semiconductors or semiconducting devices or semiconducting thin layers or substrates, comprising:
a) a reactor (62), for producing or growing or etching or cleaning or treating flat screens or semiconductors or semiconducting devices or thin layers or semiconducting or conducting or dielectric thin layers or substrates, or a reactor for shrinking photosensitive resins used for microcircuit lithography, or a reactor for depositing thin layers during plasma cleaning,
b) first means (64) for pumping the reactor atmosphere,
c) a treatment system of claim 50.
